(19) United States
(12) Patent Application Publication
(10) Pub. No.: US 2024/0420072 A1
(43) Pub. Date: Dec. 19, 2024

(54) METHOD FOR CONTAINER INTERNAL WEATHER ESTIMATION FROM METEOROLOGICAL DATA

(71) Applicant: HITACHI, Ltd., Tokyo (JP)

(72) Inventors: Misaki MITO, San Jose, CA (US); Arnab CHAKRABARTI, Milpitas, CA (US)

(21) Appl. No.: 18/209,792

(22) Filed: Jun. 14, 2023

(51) Int. Cl. G06Q 10/0833

(52) U.S. Cl. CPC G06Q 10/0833

(57) ABSTRACT

Systems and methods described herein are directed to estimating and managing status of a cargo, which can involve obtaining shipping information of the cargo; extracting a first set of weather information received from one or more databases from one or more locations corresponding to a location and time interval of the shipping information of the cargo; executing pre-processing on the first set of weather information for an input to an internal environmental model that is configured to output an estimate of an internal environment of the cargo; and obtaining the estimate of the internal environment of the cargo from internal environment model based on the input of the pre-processed first set of the weather information; wherein the first set of weather information is periodically resampled in response to updates to the shipping information of the cargo.

### BACKGROUND

### Field

The present disclosure is generally directed to container management systems, and more specifically, to systems and methods for container internal weather estimation for container management.

### Related Art

Shipping containers transport much of the world's cargo. Standardization of containers has aided global trade and brought economic efficiencies. However, shipping containers are opaque and hard to monitor, and the resulting lack of visibility into cargo condition is the cause of damage and waste resulting in economic loss, delay, and several kinds of risk ranging from environmental to legal. In recent decades, an increasing number of shipments have been monitored by Internet of Things (IoT) sensors that provide partial visibility into cargo location, condition, and so on.

In the related art, there is an estimated sensor data (temperature, water vapor pressure (≈humidity)) inside a container using measured sensor data (temperature, humidity, solar radiation) outside a container using a multi-regression model. The above model and condensation condition are used to estimated condensation probability using the above model.

In the related art, there are implementations that attach sensors to containers in transit and records the value of each sensor (gyro, inertia, humidity, temperature, light, strain, and so on) and its confidence level to determine if the item was properly managed (no damage, spoilage, theft, and so on). The reliability is calculated by inputting the sensor values into a reliability determination model using machine learning. Data can be stored on a blockchain.

### SUMMARY

Example implementations described here involve a “sensor-less” solution. Using external weather data to estimate a container's internal weather can add significant value when the shipping container does not have sensors, when there is sensor failure, when the shipment is planned for the future, and so on.

The value of having visibility into cargo in transit is widely acknowledged. There are related art implementations on verifying the state of items in transit. However, nearly all related art implementations assume that measuring devices (sensors) are present to measure the environment inside a shipping container. Unfortunately, installing sensors in containers is expensive. Not all containers have sensors.

Further, there are use cases when the shipment is planned sometime in the future, hence no measurements exist yet, but there is still a need to estimate the risk of the future shipment. It is helpful to have a fallback in case a container's internal measurements are not known. Example implementations described herein facilitate such a fallback based on external weather data. The present disclosure further addresses practical problems one faces in implementing such a solution—problems relating to spatio-temporal synchronization, model creation and ultimately estimation leading to risk mitigation.

In a first problem to be solved, there can be unsynchronized data. Sensor data inside and outside a container may be measured at different points in time and also from slightly different locations. In particular, when outside data is obtained from a meteorological source, its timing and location are unlikely to match precisely with the sensors inside the cargo being measured. This asynchronism presents a challenge in the training phase when a model translating external data into internal data is constructed.

External weather measurements input to models that translate outside weather data to inside weather data can provide a container's inside weather data without sensors. Container data must be inferred from the weather data, but establishing the spatio-temporal correspondence of the data in training is a key step. Example implementations described herein can facilitate ensuring such correspondence to address such a technical problem preventing the related art from implementing similar models.

Container data is often measured in irregular time periods because sensor-attached containers usually telecommunicate for real-time tracking under unstable environments. In addition, time-series models and some other estimation methods usually require data at synchronized regular sampling intervals.

In a second technical problem, the estimation depends on the voyage in the related art. Container data (risk) depends on the direction of routes, time, and area. Related art implementations tend to only evaluate a small number of cargoes modeled with different linear equations, and the development cost of their solution is high because a fresh model must be added for each new voyage.

In a third technical problem, there is inaccurate or missing risk mitigation. The related art does not suggest risk mitigation methods, which falls short of addressing the main pain point—cargo degradation—and therefore has insufficient economic benefit.

In a fourth technical problem, there can be containers with unknown contents. The item/customer's name of the container may not be known unless the customer shares this information, or unless the information is inferred from another source such as customs data.

The example implementations described herein can estimate container parameters and state/risk optionally with customer/item information without IoT sensors. The example implementations also synchronize data time-stamp/geo-position and generates regular time data for training/estimating the estimation model. In addition, the example implementations can suggest risk mitigation methods for users. Weather data can be used for estimating past and future data (using weather forecast).

Aspects of the present disclosure can involve a method for estimating and managing status of a cargo, which can involve obtaining shipping information of the cargo; extracting a first set of weather information received from one or more databases from one or more locations corresponding to a location and time interval of the shipping information of the cargo; executing pre-processing on the first set of weather information for an input to an internal environmental model that is configured to output an estimate of an internal environment of the cargo; and obtaining the estimate of the internal environment of the cargo from internal environment model based on the input of the pre-processed first set of the weather information; wherein the first set of weather information is periodically resampled in response to updates to the shipping information of the cargo.

Aspects of the present disclosure can involve a computer program storing instructions for estimating and managing status of a cargo, which can involve obtaining shipping information of the cargo; extracting a first set of weather information received from one or more databases from one or more locations corresponding to a location and time interval of the shipping information of the cargo; executing pre-processing on the first set of weather information for an input to an internal environmental model that is configured to output an estimate of an internal environment of the cargo; and obtaining the estimate of the internal environment of the cargo from internal environment model based on the input of the pre-processed first set of the weather information; wherein the first set of weather information is periodically resampled in response to updates to the shipping information of the cargo. The computer program and instructions can be stored on a non-transitory computer readable medium and executed by one or more processors.

Aspects of the present disclosure can involve a system for estimating and managing status of a cargo, which can involve means for obtaining shipping information of the cargo; means for extracting a first set of weather information received from one or more databases from one or more locations corresponding to a location and time interval of the shipping information of the cargo; means for executing pre-processing on the first set of weather information for an input to an internal environmental model that is configured to output an estimate of an internal environment of the cargo; and means for obtaining the estimate of the internal environment of the cargo from internal environment model based on the input of the pre-processed first set of the weather information; wherein the first set of weather information is periodically resampled in response to updates to the shipping information of the cargo.

Aspects of the present disclosure can involve an apparatus, configured for estimating and managing status of a cargo, which can involve a processor, configured to obtain shipping information of the cargo; extract a first set of weather information received from one or more databases from one or more locations corresponding to a location and time interval of the shipping information of the cargo; execute pre-processing on the first set of weather information for an input to an internal environmental model that is configured to output an estimate of an internal environment of the cargo; and obtain the estimate of the internal environment of the cargo from internal environment model based on the input of the pre-processed first set of the weather information; wherein the first set of weather information is periodically resampled in response to updates to the shipping information of the cargo.

### BRIEF DESCRIPTION OF DRAWINGS

FIG. 1 illustrates the information processing device, in accordance with an example implementation.

FIG. 2 illustrates the system of cargo status estimation of training phase, in accordance with an example implementation.

FIG. 3 illustrates the system of cargo status estimation of operation phase, in accordance with an example implementation.

FIG. 4 illustrates the visualizing/inputting unit, in accordance with an example implementation.

FIG. 5 illustrates an example flowchart of the training phase, in accordance with an example implementation.

FIG. 6 illustrates an example flowchart of the operation phase, in accordance with an example implementation.

FIG. 7 is an example data set of external weather data, in accordance with an example implementation.

FIG. 8 is an example data set of clean external data at regular periods, in accordance with an example implementation.

FIG. 9 is an example data set of estimated internal sensor data, in accordance with an example implementation.

FIG. 10 is an example flowchart of the customer/item specification, in accordance with an example implementation.

FIG. 11 is an example of metadata, in accordance with an example implementation.

FIG. 12 is an example data set of customer/item information, in accordance with an example implementation.

FIG. 13 is an example flowchart of the mitigation suggestion, in accordance with an example implementation.

FIG. 14 is an example data set of the mitigation plan, in accordance with an example implementation.

FIG. 15 is an example data set of suggestion information, in accordance with an example implementation.

FIG. 16 illustrates a plurality of physical systems that are networked to a management apparatus, in accordance with an example implementation.

FIG. 17 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

Example implementations described herein are described with respect to shipping containers. However, any other type of cargo can also be utilized in the example implementations, and the present disclosure is not limited thereto. The terms “cargo” and “container” may be used interchangeably throughout the present disclosure.

In the training phase, the data cleaner obtains internal sensor data and external weather data. Then, the data cleaner outputs clean external and internal data at regular periods after the cleaning (e.g., through synchronizing geology and data preparation). Then, the training phase trains the internal state estimation model by using the clean external and internal data at regular periods as output from the data cleaner. This process updates the model parameters if there is already a pre-existing model. Otherwise, this process generates that model.

Depending on the desired implementation, the external weather data can be obtained from one or more external servers or databases. The internal sensor data is measured by sensors monitoring the cargo, which can span across one or more cargo loads. Such cargo loads can be located on a truck, a ship, and/or other places depending on the desired implementation.

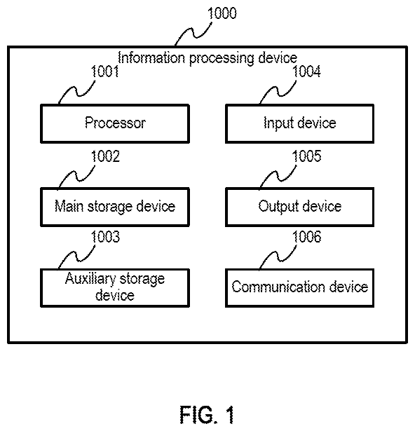

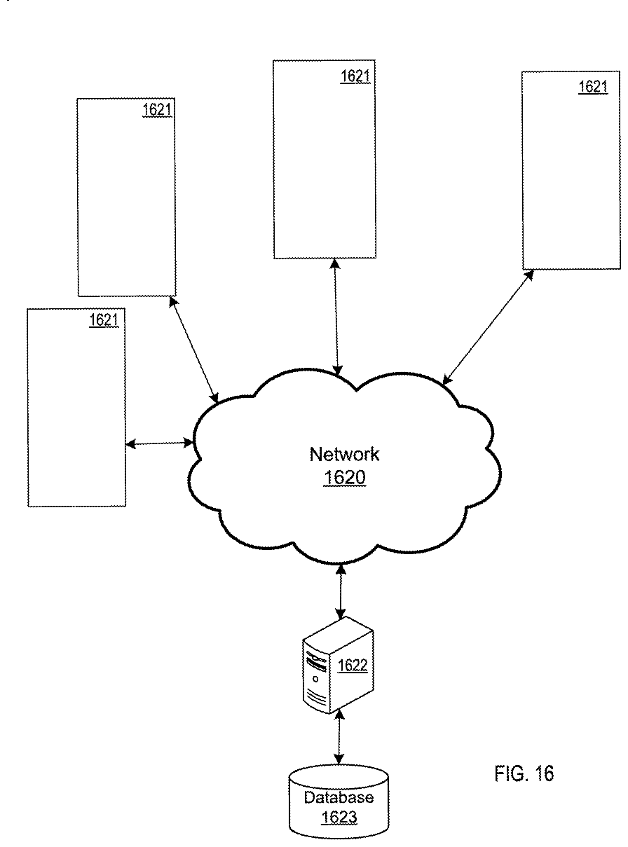

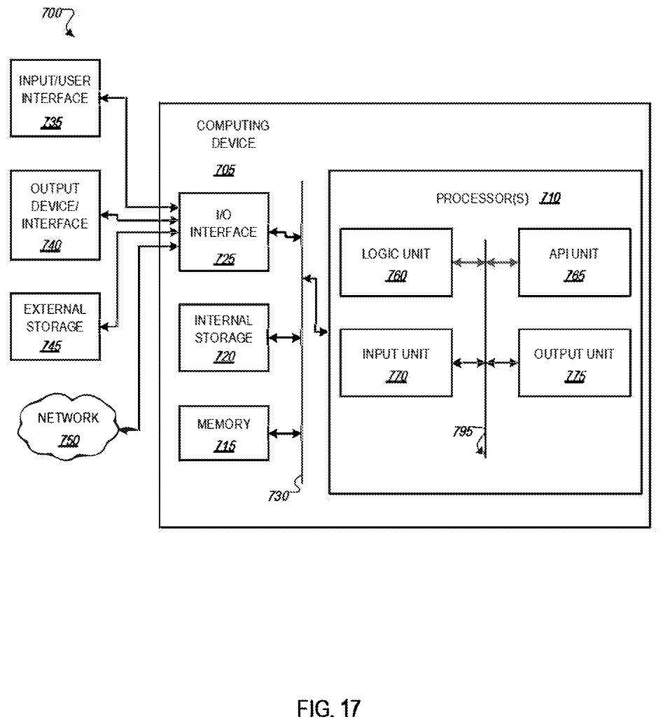

FIG. 1 illustrates an example of the information processing device 1000, in accordance with an example implementation. The information processing device 1000 can be implemented at any physical system managing cargo as described herein, such as those described with respect to FIG. 16. Such an information processing device can involve a processor 1001, a main storage device 1002 and auxiliary storage device 1003 to store local shipping information or weather information, an input device 1004, an output device 1005, and a communication device 1006 to communicate to the network and to a management apparatus as described in FIG. 16 and FIG. 17.

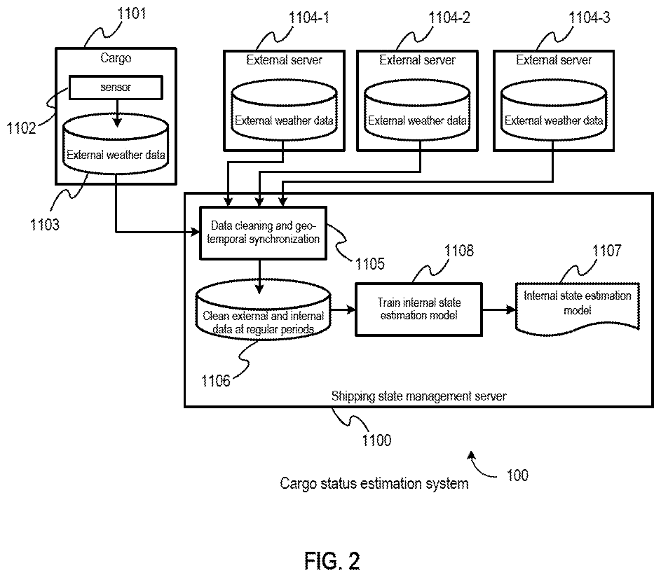

FIG. 2 illustrates a system 100 of cargo status estimation for the training phase, in accordance with an example implementation. As shown in the cargo status estimation system 100, there can be one or more cargos 1101 which are equipped with sensors 1102 that provide the internal sensor data 1103 of the cargo 1101. External servers 1104-1, 1104-2, 1104-3 are configured to provide external weather data in accordance with the desired implementation. The external weather data and the internal sensor data 1103 are provided to the shipping state management server 1100, which intakes the data and pre-processes the data with a data cleaning and geo-temporal synchronization process 1105. The cleaned and synchronized data is provided at regular periods as cleaned external and internal data 1106. The cleaned external and internal data 1106 is then used to train the internal state estimation model 1108 to either update the parameters of an existing internal state estimation model 1107 or to generate the internal state estimation model 1107 in accordance with the desired implementation.

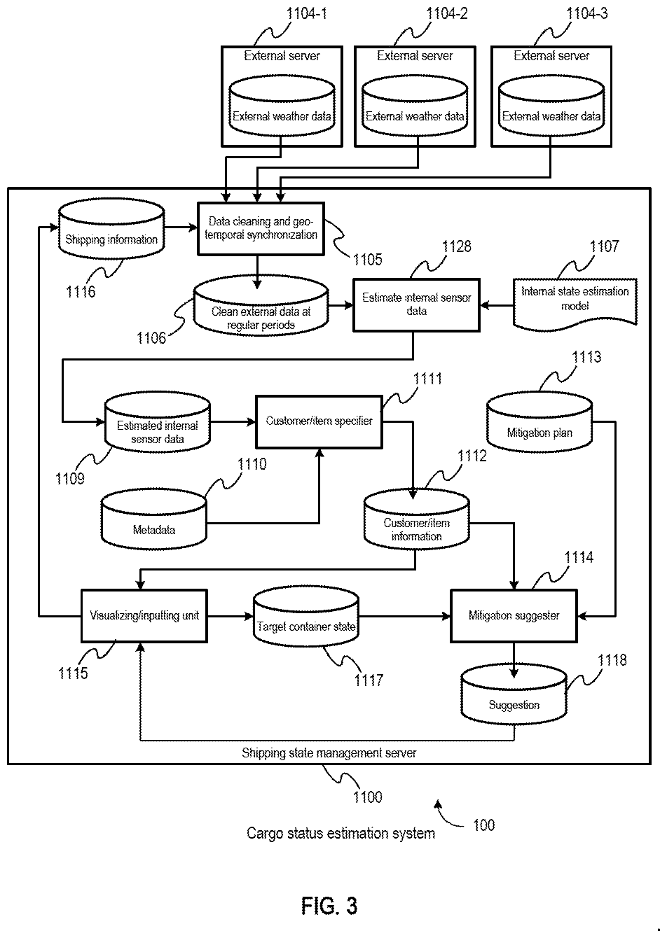

FIG. 3 illustrates a system of cargo status estimation for the operation phase, in accordance with an example implementation. Specifically, FIG. 3 illustrates other functions of the shipping state management server 1100 to facilitate cargo status estimation for a model 1107 operating in the operation phase. In the operation phase, the shipping state management server 1100 as described herein will not need sensor data, but will only need the shipping information 1116 of the cargo to be monitored.

In addition to the external weather data, the shipping information 1116 of the cargo to be estimated is also provided to the data cleaning and geo-temporal synchronization process 1105. The cleaned external data at regular periods 1106 is used with the shipping information 1116 and the operating model 1107 to estimate internal sensor data 1128 of the cargo to be estimated. The estimate is then stored as estimated internal sensor data at 1109, and provided to a customer/item specifier 1111 which intakes metadata 1110 to generate the customer/item information 1112 that is to be provided to the visualizing/inputting unit 1115 and the mitigation suggester 1114.

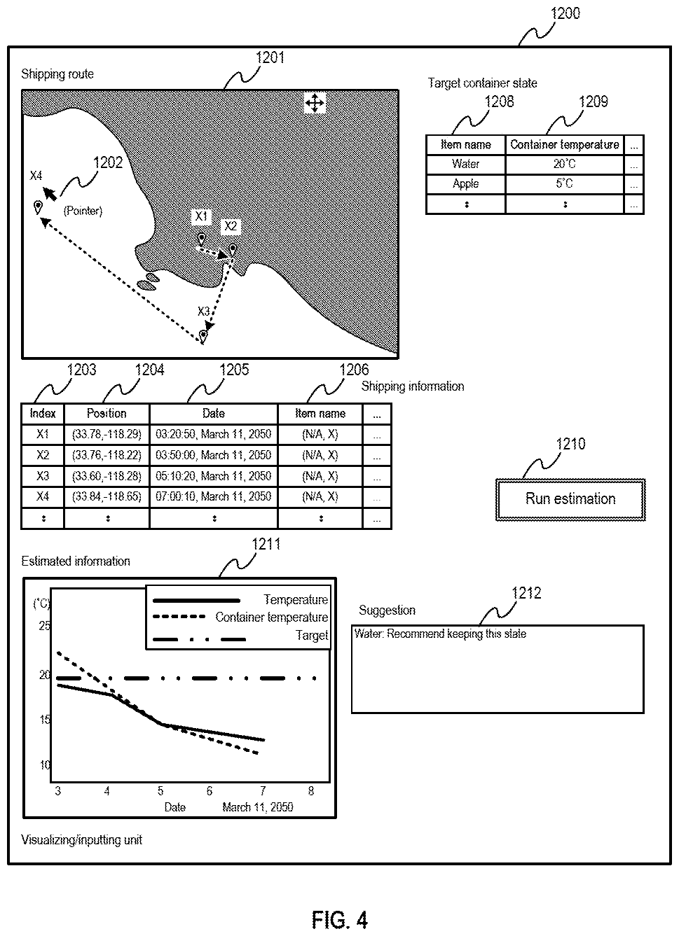

The visualizing/inputting unit 1115 is configured to facilitate and display a user interface that displays suggestions 1118 for mitigation, customer/item information 1112, and can receive inputs regarding target container state 1117. Further details of the visualizing/inputting unit 1115 is provided with respect to FIG. 4.

Mitigation suggester 1114 is configured to reference a database of mitigation plans 1113 and, based on the customer/item information 1112 and the desired target container state 1117, provides a suggestion 1118 referenced from the database of mitigation plans 1113 to achieve the target container state 1117. Such a suggestion is provided to the visualizing/inputting unit 1115 for the user to invoke through the user interface as desired.

FIG. 4 illustrates the visualizing/inputting unit 1200, in accordance with an example implementation. Specifically, FIG. 4 illustrates an example of the user interface for the visualizing/inputting unit 1200.

Shipping route 1201 illustrates an example component of the user interface that displays the shipping route of the cargo to be tracked. User can specify “Position” and “Date/Time” by pointer 1202, which can be implemented by mouse, touch screen or any other input implement in accordance with the desired implementation.

Shipping information indicates the specified index 1203, position 1204, date/time 1205, and item name 1206, if known, of the cargo to be monitored, as well as other information in accordance with the desired implementation. The shipping information can be obtained from the physical platform, can be entered through the visualizing/inputting unit 1200, or through any other desired implementation. The user can edit the index 1203, position 1204, date/time 1205, and so on. Such fields can also be filled by shipping route 1201 operation. For example, when supplied with start and end dates and locations, a shipping route/itinerary can be generated by an algorithm, search of past shipments, and so on. Although the example implementations illustrated in FIG. 4 are directed to the item name 1206, other information can also be used in accordance with the desired implementation. For example, customer name or other indicia can be used to specify this item. Depending on the desired implementation, the item name 1206 of the container/cargo can also be filled by using meta data if this field is otherwise vacant.

The target container state can involve item name 1208, container temperature 1209, and other information in accordance with an example implementation. In the interface for the target container state, the user can specify the desired target value for the container state. For example, item name 1208 and container temperature 1209 can be specified as the sample name for managing the target, and target the temperature inside a container.

Run estimation 1210 is a button that when triggered, can generate the estimated information 1211 and suggestions 1212. Estimated information 1211 visualizes the estimated information of the weather data and the managing risk (container state) when the run estimation button is pushed. Suggestion 1212 suggests a risk mitigation method with the customer/item name of the container.

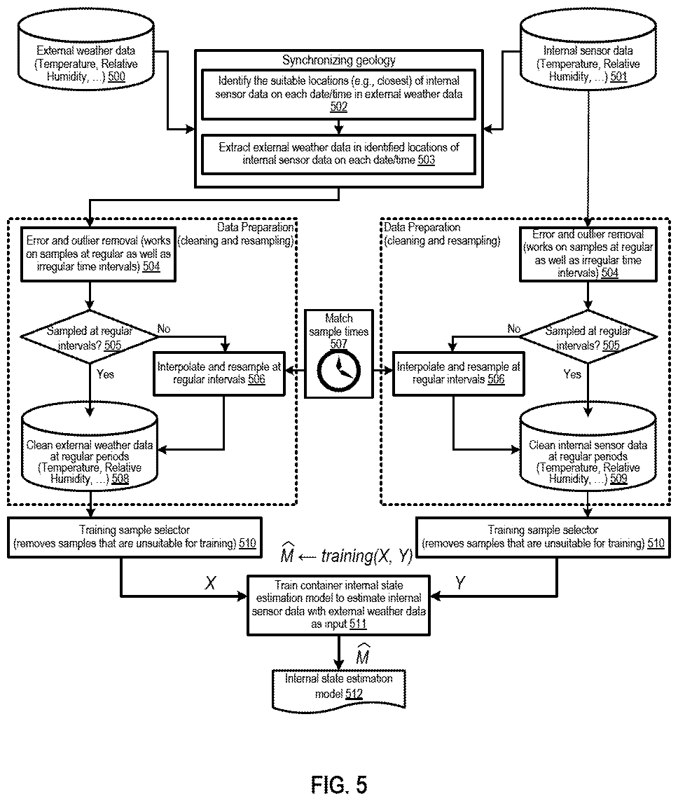

FIG. 5 illustrates an example flowchart of the training phase, in accordance with an example implementation. Historical databases are referenced for external weather data (e.g., temperature, relative humidity, etc.) 500 and historical internal sensor data (e.g., temperature, relative humidity, etc.) 501 to attempt to synchronize the historical external weather data and historical internal sensor data to train and learn the relationships between the two.

For the synchronizing geology, the process first identifies the suitable locations (e.g., closest) of the historical internal sensor data for each date/time in the external weather data at 502. At 503, the flow extracts external weather data in the identified locations of the internal sensor data at each date/time of the historical internal sensor data.

After the synchronizing the geology, the next process involves the data preparation (cleaning and resampling the synchronized historical external weather data and the internal sensor data). At 504, error and outlier removal is conducted in the historical external weather data and historical internal sensor data. The error and outlier removal can work on samples at regular as well as irregular time intervals.

At 505, a determination is made as to whether the resulting historical external weather data and historical internal sensor data are sampled at regular intervals. If not, (No), then an interpolation process is conducted to interpolate and resample to reform the data to regular intervals at 506. The resampled and interpolated data is then matched at 507 to maintain the synchronization between the historical external weather data and historical internal sensor data.

The resulting data should be clean external data 508 and clean internal data 509 at regular periods. At 510, a training sample selector is conducted to remove samples that are unsuitable for training in accordance with the desired implementation. The remaining training samples are then used to train the container internal state estimation model 512 to estimate the internal sensor data with external weather data as input at 511.

The training of the internal state estimation model is conducted by using clean external and internal data at regular periods. This process updates the model's parameters if the internal state estimation model was previously generated. Otherwise, the internal state estimation model is generated.

The hypothesized relationship between the container's internal parameters and external weather parameters at the container's location is given by:

$$Y = M ( X , Ω )$$

where:
Y=container's internal parameters such as temperature and relative humidity,
X=external weather parameters at the container's location such as temperature and relative humidity,
Ω=other variables that may impact container's internal parameters such as container type and type of cargo

Note that the above equation assumes that X and Y correspond to the same location.

M is estimated in the training phase, resulting in the creation of a model \hat{M} that approximates M.

$$\hat{M} ← training ( X , Y )$$

Here, \hat{M} can be any type of model, and the use of other information Ω by the model \hat{M} is optional.

During use, the trained model \hat{M} acts on known external weather parameters at the container's location X to calculate Ŷ, which an estimate of the container's internal parameters:

$$\hat{Y} = \hat{M} ( X , Ω )$$

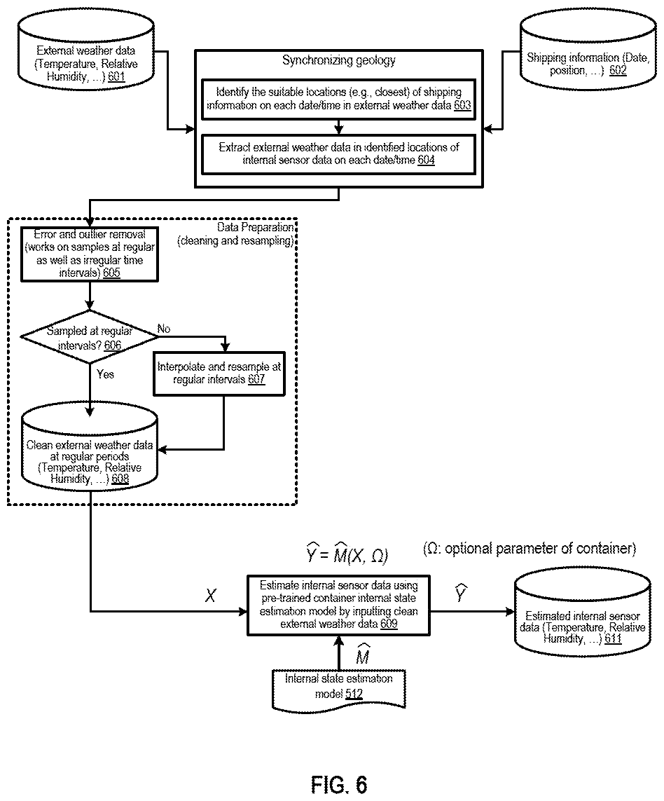

FIG. 6 illustrates an example flowchart of the operation phase, in accordance with an example implementation. The flow applies the pre-trained cargo internal state estimation model 512 to estimate internal sensor data from the input of the clean external weather data during operation of the model.

The external weather data (temperature, relative humidity, etc.) 601 is synchronized with the shipping information (date, position, etc.) 602 of the physical system (e.g., shipping boat, truck, docking port, etc.) managing the cargo to be estimated. For the synchronizing geology, at 603, the flow identifies the suitable locations (e.g., closest) of the shipping information on each datetime in the external weather data. At 604, the flow extracts the external weather data in the identified locations of the internal sensor data at each date/time.

Once the corresponding external weather data is extracted, the data preparation (cleaning and resampling) is conducted. At 605, error and outlier removal is conducted on the synchronized external weather data and the shipping information. At 606, a determination is made if the external weather data sampled at regular intervals. If not (No) then the flow proceeds to 607 to interpolate and resample the external weather data to convert it to regular intervals. At 608, the resulting data is cleaned external weather data at regular periods.

At 609, the internal state estimation model 512 intakes the cleaned external weather data at regular periods to estimate the internal sensor data, and provides the estimation of the internal sensor data (e.g., temperature, relative humidity).

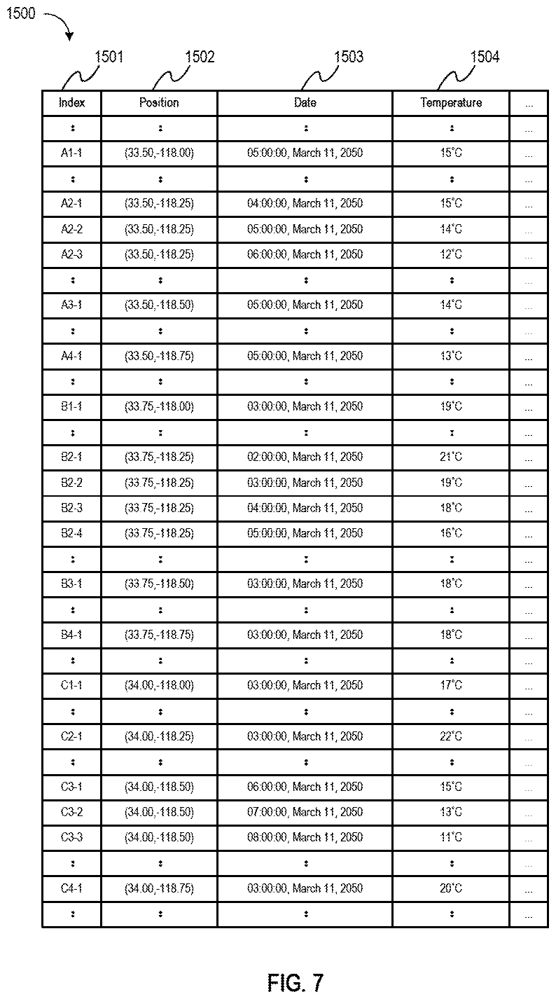

FIG. 7 is an example data set of external weather data 1500, in accordance with an example implementation. Examples of the external weather data can include temperature with date/time corresponding to geographic information (e.g., position in the example of FIG. 7). In the example of FIG. 7, external weather data is gathered in one place. However, external weather data can be collected across multiple external servers that also has geographic information (e.g., server location).

The external weather data 1500 can have fields such as, but not limited to, the index of the entry 1501, the position 1502 of the weather, the date/time 1503, and the temperature 1504. Other fields such as relative humidity can also be used, and the present disclosure is not limited thereto. Position 1502 can involve coordinates such as global positioning satellite (GPS) or other methods depending on the desired implementation.

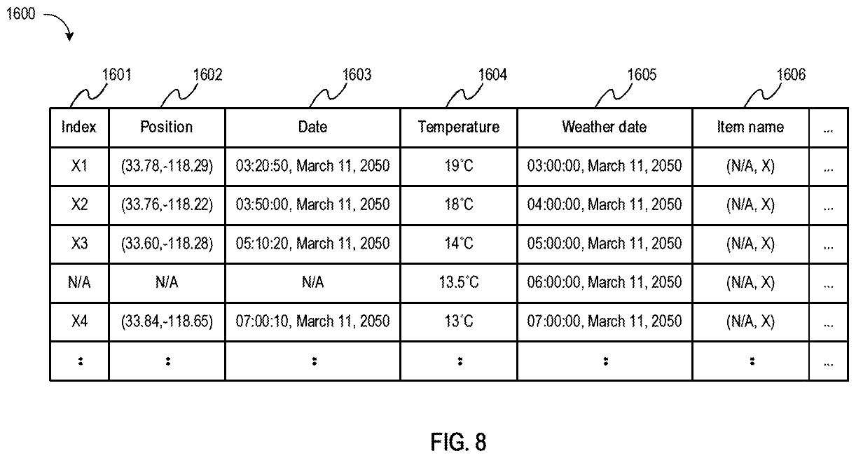

FIG. 8 is an example data set of clean external data at regular periods 1600, in accordance with an example implementation. Example fields to the clean external data at regular intervals 1600 can include, but are not limited to, the index of the entry 1601, the position 1602, the date 1603, the temperature 1604, the weather date/time 1605, and the item name 1606. Item name 1606 can involve metadata, identification of the cargo/container, name of the customer, and so on, depending on the desired implementation.

In the example of FIG. 8, weather data can involve temperature 1604 and the corresponding weather date/time 1605 from the weather model used for interpolation. Temperature 1604 can be shown on the estimated information portion in the visualizing/inputting unit along with weather date/time 1605. The example of FIG. 8 also illustrates the case of taking over all data fields of past processes (e.g., date and others). Some fields can be also used for detecting customer/item name in the next process.

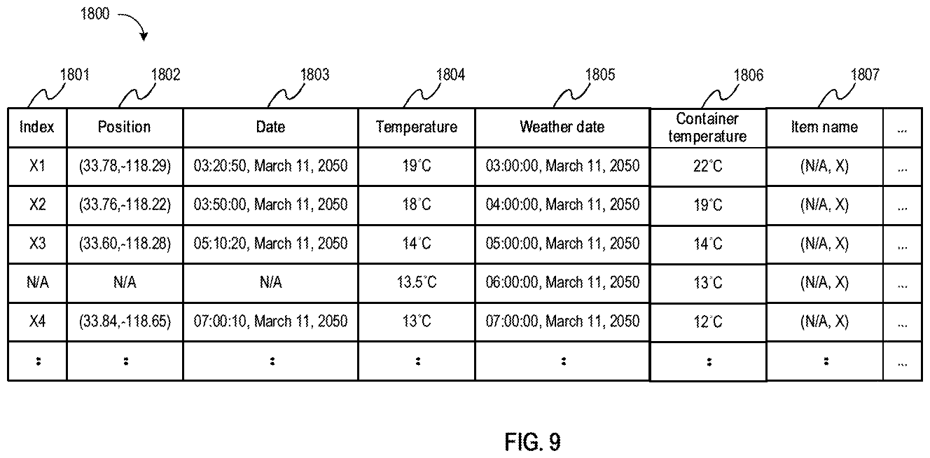

FIG. 9 is an example data set of estimated internal sensor data 1800, in accordance with an example implementation. The estimate internal sensor data 1800 can include fields such as, but not limited to, the index 1801, the position 1802, the date 1803, the temperature 1804, the weather date 1805, the estimated container temperature 1806, the item name 1807 and so on. Other fields (e.g., relative humidity) can also be utilized, and the present disclosure is not limited thereto.

Container/cargo temperature is the data of the estimated internal sensor data 1800 in the example of FIG. 9, and can be shown on the estimated information part in visualizing/inputting unit along with the weather date/time. Further, this example of FIG. 9 illustrates the possibility of taking over all data fields of past processes (e.g., date and others). Some fields can be also used for deciding the mitigation method in the next process.

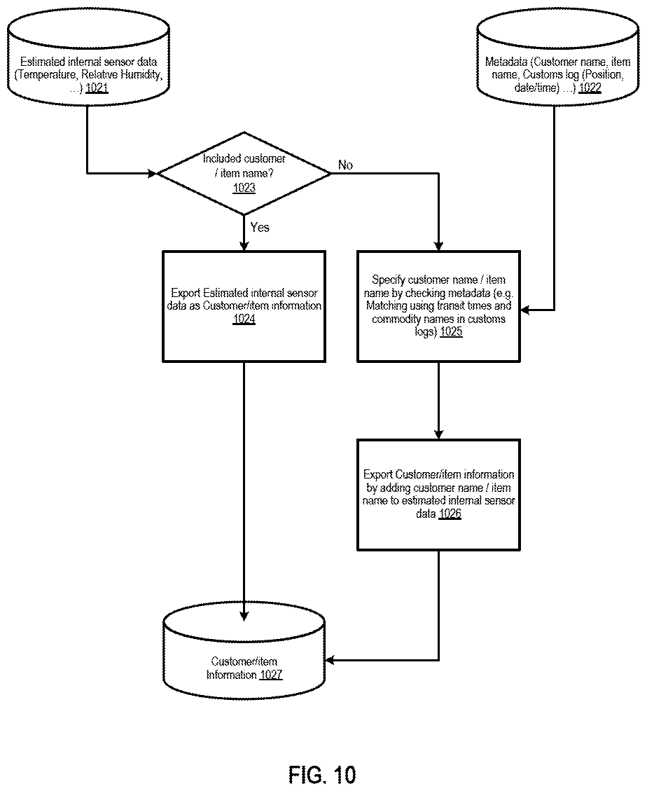

FIG. 10 is an example flowchart of the customer/item specification, in accordance with an example implementation. This flow specifies the item name of the container/cargo using metadata if this field is vacant. Item name is an example, but other information can be used in accordance with the desired implementation. For example, customer name can also be used to specify the item.

At 1023, the flow intakes the estimated internal sensor data 1021 and processes it to determine if it includes the customer name/item name. If so (yes) the flow proceeds to 1024 to export the estimated internal sensor data as customer/item information, otherwise (no), the flow proceeds to 1025. At 1025, the flow intakes metadata (e.g., customer name, item name, customs log, etc.) 1022 and specifies the customer name/item name by checking metadata (e.g., by matching using transit times and commodity names in custom logs). At 1026, the flow exports the customer/item information by adding the customer name/item name to the estimated internal sensor data. At 1027, the customer/item information 1027 is affixed to the internal sensor data.

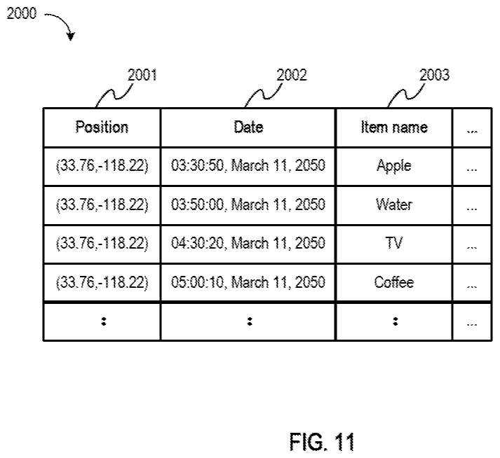

FIG. 11 is an example of metadata 2000, in accordance with an example implementation. The metadata 2000 can involve fields such as, but not limited to, position 2001, date 2002, and item name 2003. The item name 2003 can indicate the type of goods in the container/cargo, or can be other information depending on the desired implementation.

Metadata 2000 includes customer/item name 2003 and other information to detect the customer/item name 2003 from other information. In the example of FIG. 11, the metadata 2000 is in the form of customs logs. Meta data has some information (position, data) with item name. So, the customer/item specifier can detect item name by checking the relationship between shipping information and metadata 2000.

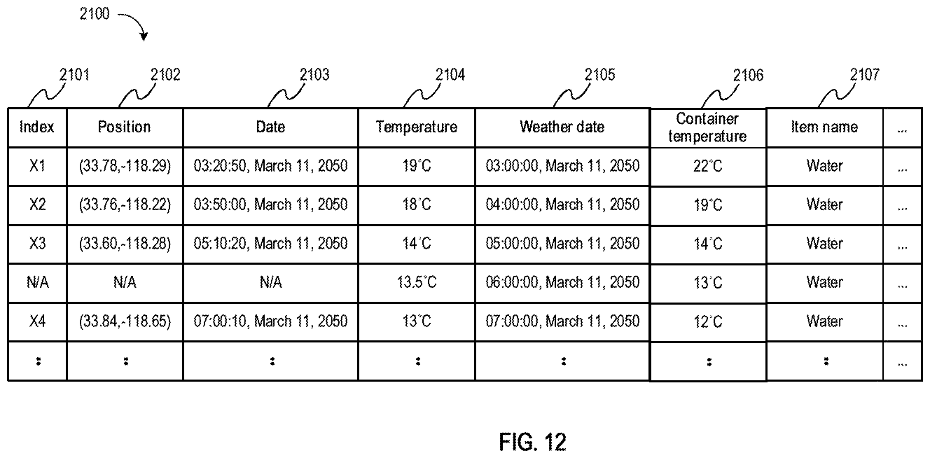

FIG. 12 is an example data set of customer/item information 2100, in accordance with an example implementation. The customer/item information 2100 can include fields such as, but not limited to, index of the entry 2101, position 2102, date 2103, temperature 2104, weather data 2105, container temperature 2106, and item name 2107.

In the example of FIG. 12, the item name 2170 (e.g., water) is an example of customer/item information in this table. The example of FIG. 12 also illustrates the possibility of taking over all data fields of past process (e.g., date and others). Some fields can be also used for deciding the mitigation method in the next process.

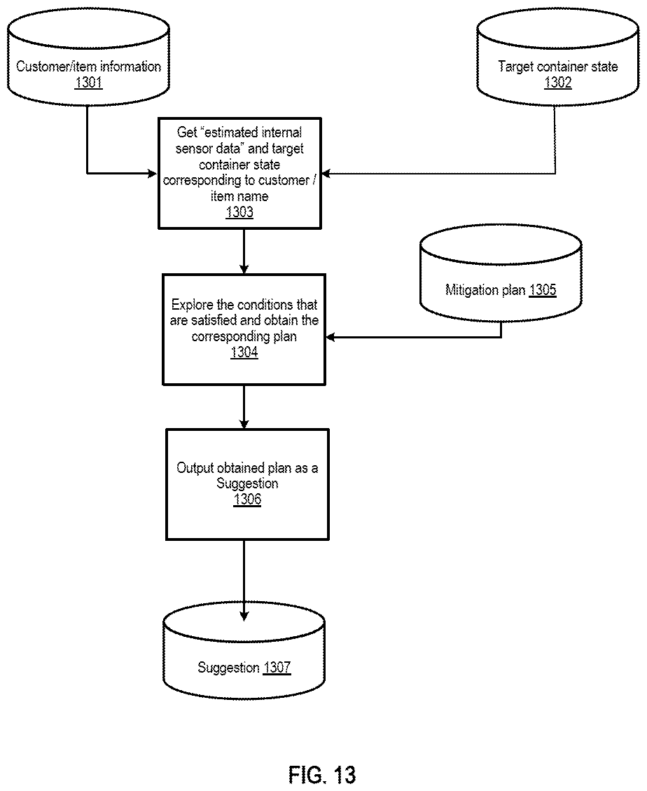

FIG. 13 is an example flowchart of the mitigation suggestion, in accordance with an example implementation. At first at 1303, the flow receives the customer/item information 1301 and the target container/cargo state 1302 specified in a user interface. At 1304, the flow then explores the conditions that are satisfied and obtains the corresponding plan from the mitigation plan database 1305. At 1306, the obtained plan is output for display in the user interface as a selectable suggestion 1307, which can be selected and executed to mitigate container/cargo damage caused by weather. Depending on the desired implementation, the suggestion can also include customer/item information for visualizing on the user interface.

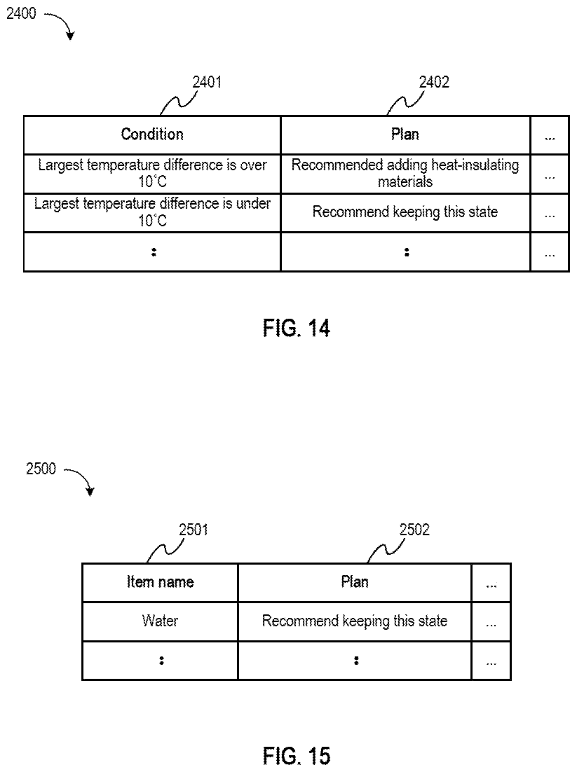

FIG. 14 is an example data set of the mitigation plan 2400, in accordance with an example implementation. The mitigation plan 2400 can involve fields such as, but not limited to, the condition required for the plan 2401, and the corresponding suggestion/plan 2402. Mitigation plan 2400 is managed by a shipping state management server or other server/database architecture in accordance with the desired implementation. In the example of FIG. 14, the mitigation plan (“Plan” in this example) is included with each selecting condition (“Condition” in this example).

FIG. 15 is an example data set of suggestion information 2500, in accordance with an example implementation. The suggestion information 2500 can involve fields such as, but not limited to, the item name 2501 and the corresponding plan 2502 for the item name. This example shows the selected suggestion from the previous process. Plan is a mandatory field including the suggestion information and shown on the suggestion interface in the visualizing/inputting unit. Item name can be used for explaining what item is required for a specific action shown in the plan. This field can used to show multiple customer/items in visualizing/inputting unit.

Through the example implementations described herein, sensor-less weather data acquisition can thereby be facilitated. Users can quickly estimate weather data inside a container by inputting the shipping date and source-destination (alternatively route or itinerary) only. Users are not required to attach/measure sensors to their ships. In addition, users can forecast weather data inside a container in shipments that are planned for the future if future data is used in the weather data.

Through the example implementations described herein, risk estimation can be facilitated in any routes. User can estimate risks inside a container/cargo from weather data by a pre-trained model. Container weather estimation for future shipments facilitates risk estimation and mitigation, by provisioning appropriate amounts of desiccants for future moisture-sensitive shipments. In addition, users can deal with insurance companies using estimated risk (value) inside specific containers.

Through the example implementations described herein, risk mitigation can thereby be facilitated. Users can know the risk mitigation methods inside a container/cargo by inputting the shipping date and source-destination (alternatively route or itinerary).

Through the example implementations described herein, customer/item information can be identified. Users can estimate weather data/risk inside a container/cargo corresponding to customer/item information although they do not own the containers/cargo. Such an ability, based largely or entirely on publicly available information, may be of use to government or regulatory agencies aiming to identify high-risk containers or routes, or to entities trying to anticipate supply chain delays due to adverse conditions.

FIG. 16 illustrates a plurality of physical systems that are networked to a management apparatus, in accordance with an example implementation. One or more physical systems 1621 (e.g., cargo boat, docketing port, truck, etc.) carrying one or more cargo loads are communicatively coupled to a network 1620 (e.g., local area network (LAN), wide area network (WAN)) through the corresponding network interface of the sensor system installed in the physical systems 1621, which is connected to a management apparatus 1622. The one or more systems 1621 may or may not be associated with sensors, depending on the desired implementation. The management apparatus 1622 manages a database 1623, which contains historical data collected from the sensor systems from each of the physical systems 1621. In alternate example implementations, the data from the sensor systems of the physical systems 1621 can be stored in a central repository or central database such as proprietary databases that intake data from the physical systems 1621, or systems such as enterprise resource planning systems, and the management apparatus 1622 can access or retrieve the data from the central repository or central database. The sensor systems of the physical systems 1621 can include any type of sensors to facilitate the desired implementation, such as but not limited to gyroscopes, accelerometers, global positioning satellite (GPS), thermometers, humidity gauges, or any sensors that can measure one or more of temperature, humidity, gas levels (e.g., CO2 gas), and so on. As described herein, the management apparatus 1622 can be configured to reach external servers to obtain pertinent weather data.

FIG. 17 illustrates an example computing environment with an example computer device suitable for use in some example implementations, such as a management apparatus 1622 as illustrated in FIG. 16. Computer device 1705 in computing environment 1700 can include one or more processing units, cores, or processors 1710, memory 1715 (e.g., RAM, ROM, and/or the like), internal storage 1720 (e.g., magnetic, optical, solid state storage, and/or organic), and/or I/O interface 1725, any of which can be coupled on a communication mechanism or bus 1730 for communicating information or embedded in the computer device 1705. I/O interface 1725 is also configured to receive images from cameras or provide images to projectors or displays, depending on the desired implementation.

Computer device 1705 can be communicatively coupled to input/user interface 1735 and output device/interface 1740. Either one or both input/user interface 1735 and output device/interface 1740 can be a wired or wireless interface and can be detachable. Input/user interface 1735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1740 may include a display, television, monitor, printer, speaker, braille, or the like. In some example implementations, input/user interface 1735 and output device/interface 1740 can be embedded with or physically coupled to the computer device 1705. In other example implementations, other computer devices may function as or provide the functions of input/user interface 1735 and output device/interface 1740 for a computer device 1705.

Examples of computer device 1705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1705 can be communicatively coupled (e.g., via I/O interface 1725) to external storage 1745 and network 1750 for communicating with any number of networked components, devices, and systems, including one or more computer devices of the same or different configurations. Computer device 1705 or any connected computer device can be functioning as, providing services of, or referred to as a server, client, thin server, general machine, special-purpose machine, or another label.

I/O interface 1725 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1700. Network 1750 can be any network or combination of networks (e.g., the Internet, local area network, wide area network, a telephonic network, a cellular network, satellite network, and the like).

Computer device 1705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1710 can execute under any operating system (OS) (not shown), in a native or virtual environment. One or more applications can be deployed that include logic unit 1760, application programming interface (API) unit 1765, input unit 1770, output unit 1775, and inter-unit communication mechanism 1795 for the different units to communicate with each other, with the OS, and with other applications (not shown). The described units and elements can be varied in design, function, configuration, or implementation and are not limited to the descriptions provided. Processor(s) 1710 can be in the form of hardware processors such as central processing units (CPUs) or in a combination of hardware and software units.

In some example implementations, when information or an execution instruction is received by API unit 1765, it may be communicated to one or more other units (e.g., logic unit 1760, input unit 1770, output unit 1775). In some instances, logic unit 1760 may be configured to control the information flow among the units and direct the services provided by API unit 1765, input unit 1770, output unit 1775, in some example implementations described above. For example, the flow of one or more processes or implementations may be controlled by logic unit 1760 alone or in conjunction with API unit 1765. The input unit 1770 may be configured to obtain input for the calculations described in the example implementations, and the output unit 1775 may be configured to provide output based on the calculations described in the example implementations.

Processor(s) 1710 can be configured to execute a method or instructions for estimating and managing status of a cargo, which can involve obtaining shipping information 602 of the cargo as illustrated in FIG. 6; extracting a first set of weather information 601 received from one or more databases from one or more locations corresponding to a location and time interval of the shipping information of the cargo as illustrated by external server 1104-1 and as described with respect to FIG. 6 and FIG. 7; executing pre-processing on the first set of weather information for an input to an internal environmental model that is configured to output an estimate of an internal environment of the cargo as illustrated at 605 to 608 of FIG. 6; and obtaining the estimate of the internal environment of the cargo from internal environment model based on the input of the pre-processed first set of the weather information as illustrated at 609 and 512 of FIG. 6 to generate estimated internal sensor data 611. Depending on the desired implementation, the flow of FIG. 6 can be executed with live updates, so that the first set of weather information is periodically resampled in response to updates to the shipping information of the cargo.

Processor(s) 1710 can be configured to execute the methods or instructions as described above, wherein the internal environmental model is trained by, from a database involving historical weather information as illustrated at 500 of FIG. 5 and historical sensor data of historical cargo as illustrated at 501 of FIG. 5, executing the pre-processing on the historical sensor data as illustrated from 504 to 508 of FIG. 5; executing the pre-processing on a second set of the historical weather information corresponding to location and time interval of the historical sensor data or pre-processed historical sensor data of the historical cargo as illustrated from 504 to 509 of FIG. 5; and training the internal environmental model to learn the pre-processed historical sensor data as output from input of the cleaned second set of the historical weather information as illustrated at 510 to 512 of FIG. 5.

Processor(s) 1710 can be configured to execute the method or instructions as described above, wherein the pre-processing on the historical sensor data can involve cleaning the historical sensor data through removal of error and outliers as illustrated at 504 of FIG. 5; and interpolating and resampling the historical sensor data to form the historical sensor data into a regular time series as illustrated from 505 to 509 of FIG. 5.

Processor(s) 1710 can be configured to execute the method or instructions as described above, wherein the pre-processing on the second set of the historical weather information can involve interpolating the second set of the historical weather information to match the time interval of the historical sensor data or the pre-processed sensor data as illustrated from 504 to 508 of FIG. 5.

As described herein, historical sensor data 501 can involve any kind of environmental variables measured by sensors of historical cargo. Such environmental variables can include, but are not limited to, temperature, relative humidity, and so on depending on the desired implementation.

Processor(s) 1710 can be configured to execute the method or instructions as described above, and further involve updating the internal environmental model 1107 with the pre-processed first set of the weather information as described with respect to FIG. 2. That is, if the internal state estimation model 1107 has been previously generated, then the updates to the weather information can be used to further update the internal environmental model.

Processor(s) 1710 can be configured to execute the method or instructions as described above, wherein the pre-processing of the first set of the weather information can involve cleaning the first set of weather information through removal of error and outliers as illustrated at 605 of FIG. 6; and interpolating or resampling the first set of the weather information to match the time interval as illustrated at 607 of FIG. 6.

Depending on the desired implementation the weather data 601 can involve time, and meteorological data such as temperature, relative humidity, and others depending on the desired implementation and as illustrated in FIG. 7.

Depending on the desired implementation, the shipping information can involve itinerary information (e.g., the shipping route or start/end of the cargo) and time information corresponding to the itinerary information of the cargo.

Depending on the desired implementation, a mitigation plan can be retrieved from a database and executed in response to the estimate of the internal environment exceeding pre-determined parameters as illustrated in FIG. 4 and as based on the preconditions as illustrated in FIGS. 14 and 15.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A method for estimating and managing status of a cargo, comprising:
obtaining shipping information of the cargo;
extracting a first set of weather information, received from one or more databases from one or more locations corresponding to a location or time interval of the shipping information of the cargo and interpolated with geo-temporal synchronization using the shipping information;
executing pre-processing on the first set of weather information for an input to an internal environmental model that is configured to output an estimate of an internal environment of the cargo;
obtaining the estimate of the internal environment of the cargo from the internal environment model based on the input of the pre-processed first set of the weather information, wherein the first set of weather information is periodically resampled in response to updates to the shipping information of the cargo; and
using one or more processor to perform steps to train the internal environmental model, the steps comprising:
executing pre-processing on historical sensor data comprising cleaning the first set of weather information through removal of error and outliers;
executing pre-processing on a second set of historical weather information corresponding to the location and the time interval of the historical sensor data or pre-processed historical sensor data of historical cargo; and
training the internal environmental model to learn the pre-processed historical sensor data as output from input of the pre-processed second set of the historical weather information.

2. The method of claim 1, wherein the internal environmental model is trained by a process comprising:
from a database comprising historical weather information and historical sensor data of historical cargo,
and.

3. The method of claim 2, wherein the pre-processing on the historical sensor data comprises
interpolating and resampling the historical sensor data to form the historical sensor data into a regular time series.

4. The method of claim 2, wherein the pre-processing on the second set of the historical weather information comprises interpolating the second set of the historical weather information to match the time interval of the historical sensor data or the pre-processed sensor data.

5. The method of claim 2, wherein the historical sensor data comprises environmental variables measured by sensors of historical cargo.

6. The method of claim 1, further comprising updating the internal environmental model with the pre-processed first set of the weather information.

7. The method of claim 1, wherein the pre-processing of the first set of the weather information comprises
interpolating or resampling the first set of the weather information to match the time interval.

8. The method of claim 1, wherein the weather information comprises time, and meteorological data.

9. The method of claim 1, wherein the shipping information comprises itinerary information and time information corresponding to the itinerary information of the cargo.

10. The method of claim 1, wherein a mitigation plan is retrieved from a database and executed in response to the estimate of the internal environment exceeding pre-determined parameters.

11. A non-transitory computer readable medium, storing instructions for estimating and managing status of a cargo, the instructions comprising:
obtaining shipping information of the cargo;
extracting a first set of weather information, received from one or more databases from one or more locations corresponding to a location or time interval of the shipping information of the cargo and interpolated with geo-temporal synchronization using the shipping information;
executing pre-processing on the first set of weather information for an input to an internal environmental model that is configured to output an estimate of an internal environment of the cargo;
obtaining the estimate of the internal environment of the cargo from internal environment model based on the input of the pre-processed first set of the weather information, wherein the first set of weather information is periodically resampled in response to updates to the shipping information of the cargo; and
performing steps to train the internal environmental model, comprising:
executing pre-processing on historical sensor data comprising cleaning the first set of weather information through removal of error and outliers;
executing pre-processing on a second set of historical weather information corresponding to the location and the time interval of the historical sensor data or pre-processed historical sensor data of historical cargo; and
training the internal environmental model to learn the pre-processed historical sensor data as output from input of the pre-processed second set of the historical weather information.

12. A system, comprising:
one or more physical systems associated with cargo; and
a management apparatus configured to estimate and manage status of the cargo, comprising:
a processor, configured to:
obtain shipping information of the cargo;
extract a first set of weather information, received from one or more databases from one or more locations corresponding to a location or time interval of the shipping information of the cargo and interpolated with geo-temporal synchronization using the shipping information;
execute pre-processing on the first set of weather information for an input to an internal environmental model that is configured to output an estimate of an internal environment of the cargo;
obtain the estimate of the internal environment of the cargo from internal environment model based on the input of the pre-processed first set of the weather information, wherein the first set of weather information is periodically resampled in response to updates to the shipping information of the cargo; and
the processor further configured to, in a training phase:
execute pre-processing on historical sensor data comprising cleaning the first set of weather information through removal of error and outliers;
execute pre-processing on a second set of historical weather information corresponding to the location and the time interval of the historical sensor data or pre-processed historical sensor data of historical cargo; and
train the internal environmental model to learn the pre-processed historical sensor data as output from input of the pre-processed second set of the historical weather information.

13. The method according to claim 1, wherein the internal environmental model is trained by a process comprising:
hypothesizing a relationship between a container's internal parameters and external weather parameters at the container's location; and
using the hypothesized relationship to perform at least one of generating on internal environment model and applying the hypothesized relationship to the internal environment model or applying the hypothesized relationship to an existing internal environment model to update parameters of the respective generated or existing internal environment model to predict one or more internal conditions.

14. The non-transitory computer readable medium according to claim 11, wherein the internal environmental model is trained by a process comprising:
hypothesizing a relationship between a container's internal parameters and external weather parameters at the container's location; and
using the hypothesized relationship to perform at least one of generating on internal environment model and applying the hypothesized relationship to the internal environment model or applying the hypothesized relationship to an existing internal environment model to update parameters of the respective generated or existing internal environment model to predict one or more internal conditions.

15. The system according to claim 12, wherein the internal environmental model is trained by a process comprising:
hypothesizing a relationship between a container's internal parameters and external weather parameters at the container's location; and
using the hypothesized relationship to perform at least one of generating on internal environment model and applying the hypothesized relationship to the internal environment model or applying the hypothesized relationship to an existing internal environment model to update parameters of the respective generated or existing internal environment model to predict one or more internal conditions.

16. The system according to claim 1, wherein the weather information is received from one or more databases and corresponds to the location or time of a cargo shipment.

17. The system according to claim 1, further comprising using at least one of a spatio-temporal or geo-temporal synchronization process that comprises an interpolation in time and space.
